(19) United States
(12) Patent Application Publication
(10) Pub. No.: US 2006/0207197 A1
(43) Pub. Date: Sep. 21, 2006

(54) Trim and method of installation

(76) Inventor: Carl H. Anderson, Scranton, PA (US)

Correspondence Address: KATTEN MUCHIN ROSENMAN LLP, 575 MADISON AVENUE, NEW YORK, NY, 10022-2585, US

(21) Appl. No.: 11/372,985

(22) Filed: Mar. 10, 2006

Related U.S. Application Data
(60) Provisional application No. 60/660,535, filed on Mar. 10, 2005.
(60) Provisional application No. 60/757,981, filed on Jan. 11, 2006.

(51) Int. Cl. E06B 1/04

(52) U.S. Cl. 52/211

(57) ABSTRACT

The inventive trim for exterior surfaces has at least two trim components positioned relative to one another so as to define a space receiving a plurality of crudely cut ends of siding. The trim components have respective engaging elements coupleable to one another to provide a detachable connection between the trim components. The trim, when used to cover an opening, such as a door or window, has a corner block configured with a pair of converging flanges which detachably engage a plurality of trim pieces.

### CROSS-REFERENCE TO RELATED APPLICATIONS

This application claims priority to U.S. Provisional Application Ser. No. 60/660,535 filed on Mar. 10, 2005 and U.S. Provisional Application 60/757,981 filed on Jan. 11, 2006, both of which are incorporated in their entirety by reference.

### BACKGROUND OF THE INVENTION

1. Field of the Invention

The invention relates to an improved building trim and a method for installing same.

2. Description of Related Art

Siding is used to cover interior and exterior surfaces of commercial and residential structures. Trim is typically placed around the ends of the siding on flat and angular surfaces and accommodates the expansion and contraction of the siding beneath the molding surface. Trim may be manufactured as a single piece unit that is bent to accommodate inside and outside corners of a surface. However, shaping trim may compromise its structural integrity because of cracks and/or weakened regions of the trim's body.

Typically, individual trim pieces are coupled to an exterior surface before siding pieces are installed. Providing the trim under the siding pieces is customary since the inner position of the trim provides the entire structure with improved weather-resistant characteristics. Consequently, to have the exterior surfaces to be covered esthetically appealing, all siding must be fastidiously cut and accurately placed into the previously installed molding trim. Hence, covering the exterior surfaces is an onerous and time-consuming process that often does not produce the desired results.

To overcome a sloppy appearance of exterior surfaces, the industry often uses a U-shaped trim. During installation, the known trim is nailed to a surface to be covered. It is desirable to drive siding nails as close to the central, bottom portion of the U-shaped trim as possible to provide a reliable attachment of the unit to the surface to be covered. However, the U-shaped configuration of the unit makes it impossible. As a consequence, the craftsman drives the nails through elongated nail slots formed along the outer edge of the unit's side which opposes a surface to be covered. Seemingly, if the nails are tightly driven, the unit's attachment is more reliable. However, as an ambient temperature changes, materials, such as aluminum or vinyl, from which the unit is made, either expand or contract causing, thus, deterioration of the trim. On the other hand, if a trim piece is not tightly attached to the surface to be covered, the siding would appear inaccurately installed and loosely positioned.

Attaching exterior trim around openings, such as doors or windows formed in an exterior surface, may pose additional problems. When trimming a corner of openings, two trim pieces are butt-joined at an angle leaving a corner joint susceptible to water and dirt intrusion and collection. Butt-joints inherently rely on the skill of the craftsman to make them look good. An unskilled craftsman needs only to err in the angle of a joint or in placement of the trim piece for the joint to look more like a gap than a joint.

Moreover, when a joint is formed of the ends of longitudinal trim pieces it is subject to maximal thermal expansion that leaves the joint wide open during the cold and wetness of winter. Consequently, water accumulates in and behind the joint only to undergo destructive freeze and thaw cycles.

A need, therefore, exists for a molding trim that is primarily configured to cover exterior surfaces in a simple and time-effective manner.

Another need exists for a molding trim that can preserve its structural integrity under adverse climatic conditions.

Still another need exists for a trim to cover crudely cut end regions of siding and to provide an aesthetically appealing appearance over covered siding ends.

Yet another need exists for a labor and time effective method of installing the inventive improved trim.

A further need exists for a corner trim piece that is easily attachable to trims and provides a reliable weather barrier.

### SUMMARY OF THE INVENTION

The present invention meets the needs noted above and, therefore, provides for a trim and a corner trim, each of which has an easily installable structure.

The basic structure of the inventive trim includes a generally L-shaped inner component provided with a base that is laid atop the exterior surface to be covered and a sidewall that extends outwardly from and transversely to the base. In addition, the base has an engaging element extending generally parallel to the sidewall and having a coupling unit. The inventive trim further has an outer component structured substantially similar to the inner component. During the installation, the outer component faces the inner component and, upon applying an external force to the outer component, the engaging elements of both components are coupled to one another to secure the mated components in the desired locking position.

Made from polymeric or metal-based material, the engaging elements are capable of flexing in response to the external force produced by an external force and, thus, allow the inner and outer engaging elements to slide relative to one another to the desired or locking position. Due to the two-component configuration of the inventive trim, its installation is labor and time effective and results in the a pleasing appearance of the surface to be covered.

The inventive trim also eliminates the necessity of having relatively large elongated slots configured to receive siding nails, which, as discussed above, are conventionally used by the exterior siding industry for coupling the trim to the surface to be covered. Instead, the inventive trim may have a plurality of relatively small holes spaced inwardly from the inner component's free end and sized to receive relatively small trim nails. Based on a long-time observation, the use of trim nails substantially minimizes rippling.

A further modification of the inventive structure includes the application of the inventive multi-piece molding trim to a variety of the exterior surface locations that are difficult to access. In accordance with one aspect of the invention, the inventive trim may be used to cover flat exterior surfaces. In another aspect of the invention, the inventive trim is configured to cover inner corners. A further modification of the inventive trim provides for covering outer corners.

In accordance with a further embodiment, an injection molded corner block—the structural element that often covers the corners of the windows and/or doors—is configured to snap over a pair of trim components, which extend transversely to one another. The corner block is kept in place by virtue of mating its coupling units to the trim components

The inventive corner block includes a unit having a snap-in configuration which is easy to couple to trims or accents around an opening in the exterior wall, while effectively aligning converging trim pieces, reliably covering the joint between the trim pieces and aiding in keeping these pieces together.

The inventive corner block is provided with a pair of flanges extending parallel to respective converging trim pieces in the assembled state of the molding system. Each of the flanges has a substantially U-shaped channel formed with an inner surface extending complementary to and surrounding the outer surface of the trims in the assembled state of the inventive molding system. Made from flexible material, the channels of the converging trim pieces yield to an external pushing force to allow the corner block to snap-in and cover them.

The aforementioned features and advantages of the invention will be pointed out with particularity, and will become obvious from the following detailed description of the invention, taken in conjunction with the accompanying drawings, which form an integral part thereof.

### BRIEF DESCRIPTION OF THE DRAWINGS

FIG. 1 is an orthogonal view of a molding trim configured in accordance with the invention;

FIG. 2 is an exploded view of the trim shown in FIG. 1;

FIG. 3 is a front cross-sectional view of the molding trim, as illustrated in FIGS. 1 and 2;

FIG. 4A is an orthogonal view of the inventive trim configured in accordance with a further embodiment of the invention and adapted to cover inside corners of exterior structures;

FIG. 4B is an exploded view of the trim of FIG. 4A;

FIG. 5A is an orthogonal view of the trim configured in accordance with another embodiment of the invention and adapted to cover outer edges of exterior structures;

FIG. 5B is an exploded view of the trim of FIG. 5A;

FIG. 6 is a diagrammatic view of a corner block associated wit the inventive trim of FIGS. 1-5;

FIG. 7A and 7B are a front view of a portion of a wall provided with a window opening and having corners covered by the inventive corner block of FIG. 6;

FIG. 8 is an exploded perspective view of the inventive corner illustrated with a trim component;

FIG. 9A and 9B are the bottom view of the inventive corner block of FIGS. 7A and 7B and a side view thereof, respectively;

FIG. 10 is an orthogonal bottom-side view of the inventive corner block; and

FIG. 11 is a diagrammatic sectional view illustrating inner and outer trim components of a trim coupled to one another by means of caulking.

### DETAILED DESCRIPTION

Reference will now be made in detail to several embodiments of the invention that are illustrated in the accompanying images. The images are in simplified form and are not to precise scale. For purposes of convenience and clarity only, directional terms, such as top, bottom, left, right, up, down, above, below, proximal, and distal may be used with respect to the drawings. These and similar directional terms should not be construed to limit the scope of the invention in any manner. The words “connect,” “couple,” “attach” and similar terms with their inflectional morphemes do not necessarily denote direct and immediate connections, but also include connections through mediate elements or devices.

In this application, trim is used in the singular or in the plural, as may be appropriate; trim unit designates a piece of trim; siding is used in the singular and the plural; and siding panel designates a piece of siding.

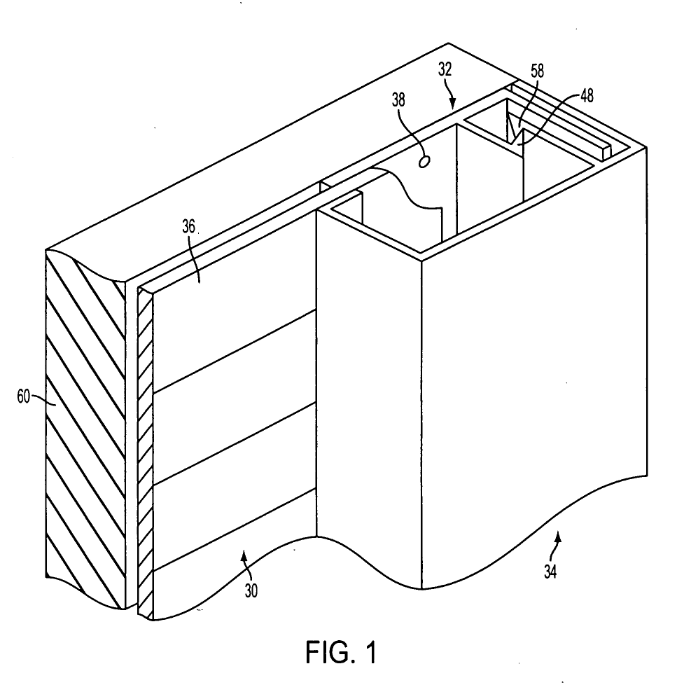

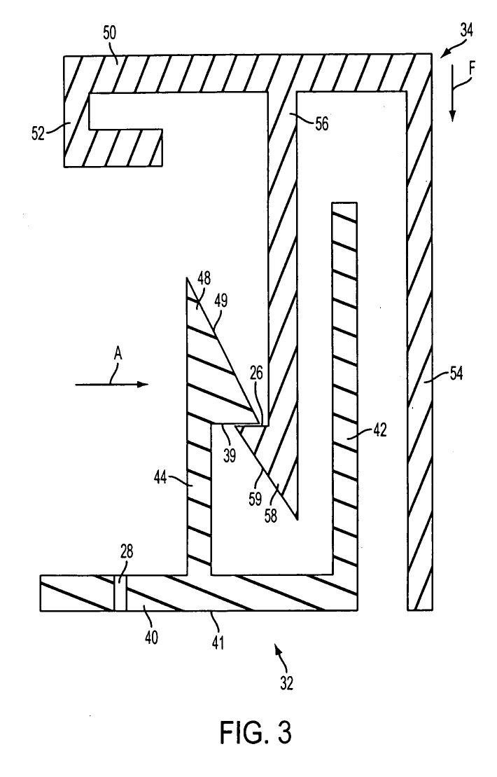

Referring to FIGS. 1-3, a trim unit 30, configured in accordance with the basic concept of the invention, includes an inner trim component 32, outer trim component 34 and a plurality of trim nails 38 (only one is shown) traversing respective holes 28 for coupling inner trim component 32 to the exterior surface of wall 60. The inner trim component 32 has a substantially L-shaped cross-section defined by a base side 40 (FIG. 3), a sidewall 42, which extends substantially perpendicular to base side 40, and an engaging element 44, which extends substantially perpendicular to base side 40 and spaced from sidewall 42. The free end 48 of engaging element 44 is formed with a substantially triangular cross-section having an underside 39 that faces base side 40. Holes 28 each preferably have a circular cross-section and are formed along base side 40 at any location between the free end of the base side and engaging element 44. Advantageously, holes 28 are located closer to engaging element 44 than to the free end of base side 40 and may be even formed between the engaging element and side wall 42 since the craftsman has an unobstructed access to these holes during the installation of the inner component. The holes 28 each have a relatively small diameter so as to be traversed by trim nails 38 (FIG. 1) which are smaller than typically used siding nails.

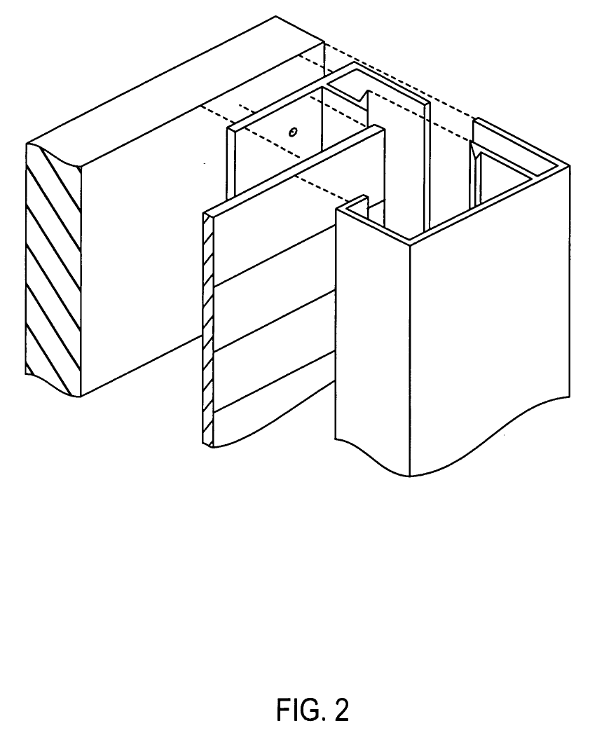

The outer trim component 34 (FIG. 3) includes a base side 50, a sidewall 54, which extends substantially perpendicular to the base side, and an engaging element 56 extending parallel to the sidewall 54 from base side 50 and having a free end 58. A free end region 52 of base side 50 has substantially a U-shaped cross-section which is configured to prevent voluntary displacement of siding pieces 36 (FIGS. 1 and 2) that are installed between the underside of U-shaped free end region 52 of outer trim component 34 and base side 40 of inner trim component 32.

During installation, the craftsman nails inner trim component 32 to the exterior surface of wall 60 (FIG. 1). Then, siding pieces 36, which may have unevenly cut outer ends, are placed, as indicated by an arrow A (FIG. 3), in the desired position, in which the cut ends of pieces 36 overlap and lie atop base side 40 (FIG. 3) of inner trim component 32. The crudely cut ends of siding panels are pressed upon by the underside of U-shaped end region 52 of outer component 34 and, thus, are reliably kept in place. As mentioned above, there is no need to accurately cut the ends of siding pieces 36 since outer trim component 34 covers these edges. The craftsman simply aligns outer component 34 with inner component 32 and presses it with a force directed along an arrow F (FIG. 3) until coupling units 48 and 58 of respective inner and outer components 32, 34 engage one another.

Although coupling units 48 and 58 are formed so as to snap over one another during the installation, the craftsman still does not have to apply particularly strong forces to outer trim component 34, since all components readily flex due a relatively small thickness of material composing these elements. As the craftsman guides outer trim component 34 inwards, complementary shaped slanted slopes or ramps 49 and 59 of coupling units 48 and 58, respectively, come into sliding contact causing the engaging elements to flex away from one another until undersides 26 and 39 of the coupling units abut one another, as shown in FIG. 3. As is shown, undersides 26 and 39 only partially overlap one another, however, coupling units 48 and 58 can be easily dimensioned to have the respective undersides to completely overlap one another. Upon coupling, engaging elements 44 and 56 assume their original position, in which these elements extend substantially parallel to one another. The installed position of trim unit 30 is also characterized by a substantially parallel relationship between sidewalls 42 and 54 (FIG. 3) of inner and outer trim components 32 and 34, respectively. Since a corner between base side 50 and sidewall 54 of outer trim component 34 is accurately pre-bent, the appearance of the assembled structure is aesthetically appealing while installation time may be substantially shorter than that one required for installation of the trim assembly of the prior art. A length of engaging elements 44 and 56 may vary and may even be not uniform, but has to be selected so that, in the installed or locking position, the bottom of sidewall 54 of outer trim component 34 terminates substantially next to exterior surface 60 (FIG. 1) and is, thus, substantially coplanar with an inner surface 41 (FIG. 3) of inner trim component 32.

While triangularly shaped free ends 48 and 58 of engaging elements 44 and 56, respectively, are shown, other configurations of coupling units are contemplated within the scope of the invention. For example, one of engaging elements 44 and 56 may be provided with a projection extending towards the other engaging element, whereas the other element has an opening sized to receive and reliably engage the projection once it is aligned with the opening (not shown).

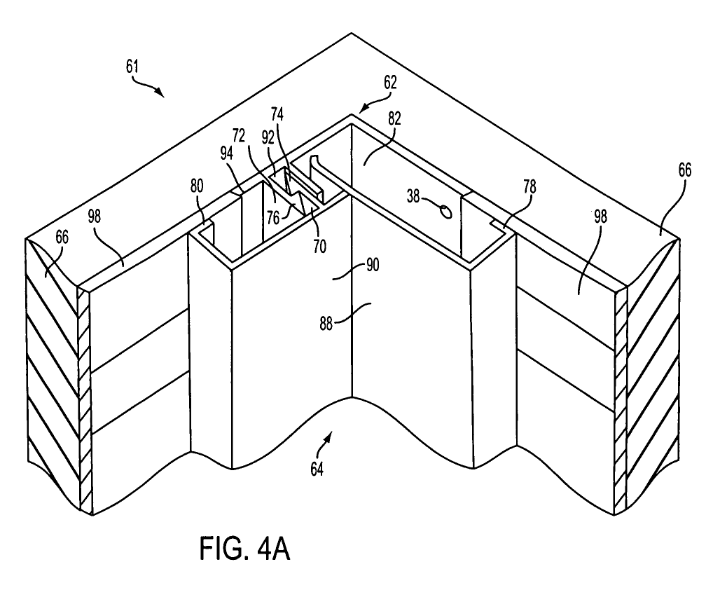

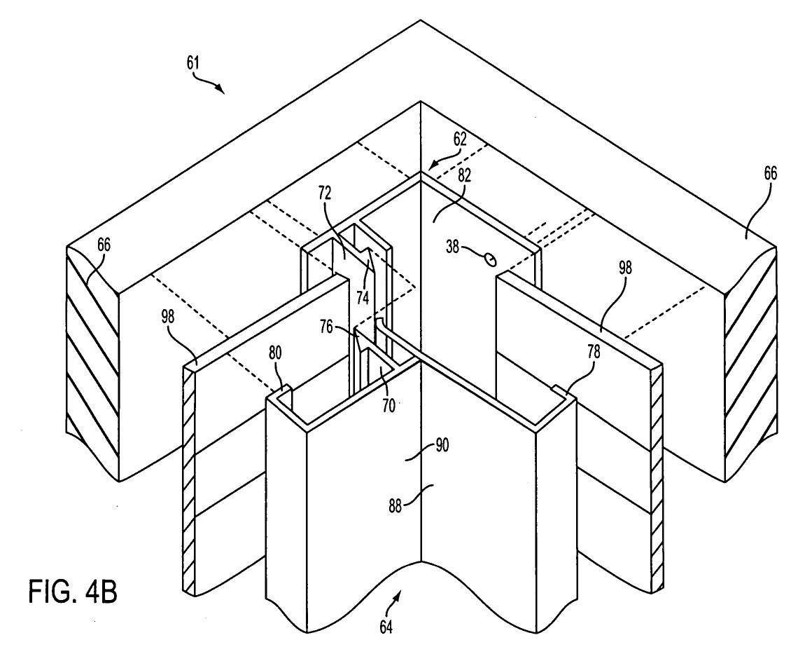

FIGS. 4A and 4B illustrate a molding trim unit 61 configured in accordance with a further embodiment of the invention and adapted to cover inside corners of an exterior surface. The method of installation is similar to the above discussed one and includes coupling an inner trim component 62 with the exterior surface of wall 66 by driving nails 68 through respective holes, placing roughly cut siding pieces 98 atop or next to a base side 94 of inner component 62 and engaging an outer component 64 with inner component 62.

The base side 94 of inner component 62 is configured with three parallel formations extending outwards from base side 94 and including a sidewall 82, an engaging element 72 and a partition 92, which is spaced between sidewall 82 and engaging element 72. A coupling unit 74, which is formed on the free end of engaging element 72, is triangularly shaped to engage a complementary shaped coupling unit 76 provided on a free end of an engaging element 70 of outer trim component 64.

During the installation of trim unit 61, the craftsman places inner component 62 so that sidewall 82 thereof extends along a portion of one of two walls 66 defining therebetween the inner corner of the surface top be covered. The partition 92 is spaced from the inside corner along the other wall of the structure and, preferably, but not necessarily, is sized to contact one of two base sides 88 and 90 of outer trim component 64.

The base sides 88 and 90 of outer component 64 each extend parallel to a respective one of walls 66 to be covered upon engagement between the trim components. The free ends 78 and 80 of base sides 88 and 90, respectively, each have a U- or J-shaped shaped end portion dimensioned to hold siding pieces 98 in place. Overall, outer trim component 64 has a generally W-shaped cross-section.

Only one of the base sides of outer component 64, for example side 90, has engaging element 70 provided with coupling unit 76, although, of course, the other base side 80 of the outer component may be provided with an engaging element as well. The coupling unit 76 of outer trim components 64 is shaped substantially similarly to coupling unit 74 of inner trim component 62 and engages the latter upon applying an external force to the outer trim component in a manner which is disclosed above in reference to FIGS. 1-3. Slight obvious modifications of trim unit 61 allowing the craftsman to caulk engaging elements 70 and 72, as explained hereinbelow, can be easily realized by those of ordinary skill in the construction art.

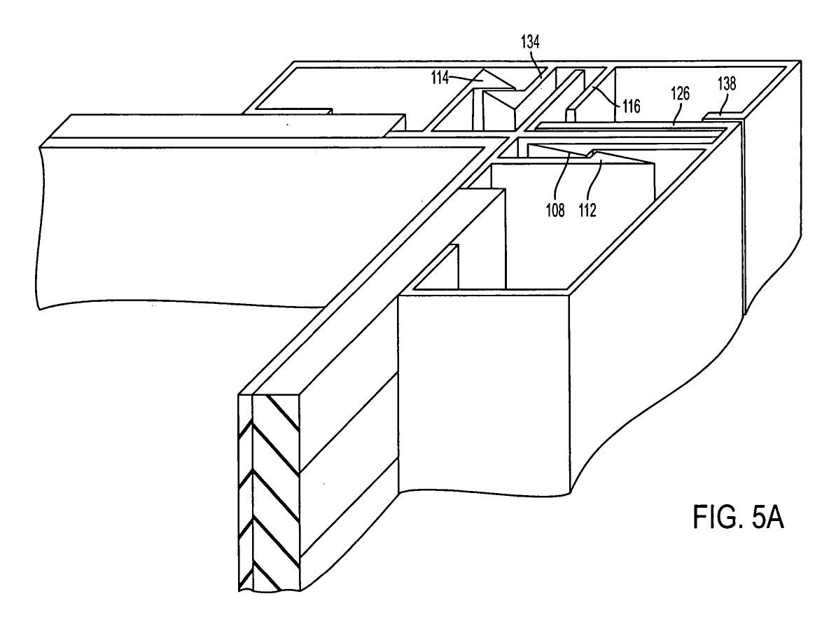

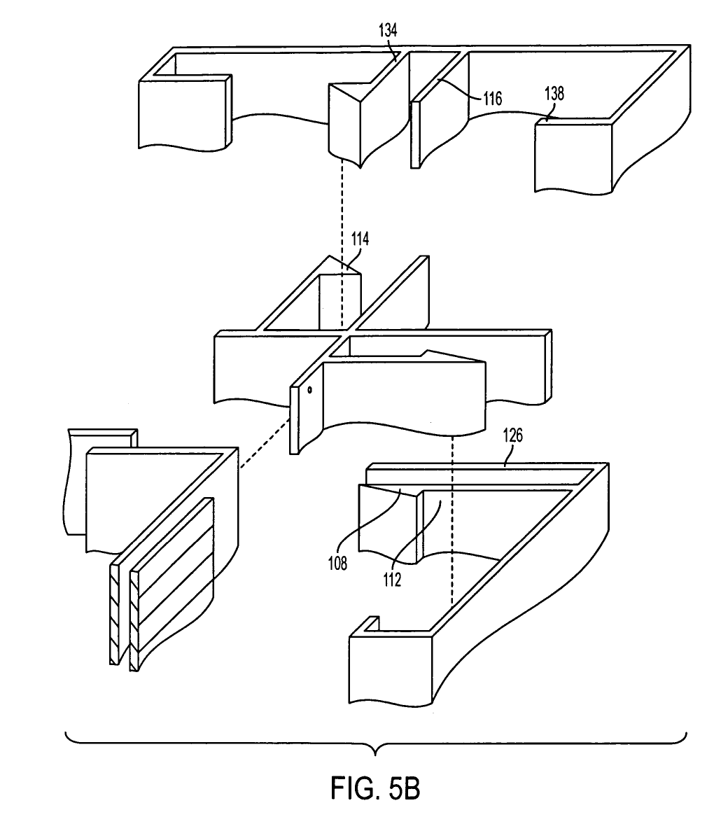

FIGS. 5A and 5B illustrate a further embodiment of inventive trim unit 100 installable to cover outside corners of external surfaces. In contrast to the previously discussed embodiments, trim unit 100 has three separate components removably attachable to one another. An inner component 102 has two base sides 116 and 120 extending transversely to one another so that an end portion 137 of base side 116 is spaced between the opposite ends of base side 120. The base sides 116 and 120 are nailed to walls 101 and 103, respectively, which diverge from one another forming, thus, an outside corner. Utilizing the main concept of the invention, base sides 116 and 120 are provided with engaging elements 108 and 110, respectively. The engaging elements 108 and 110 have respective triangularly shaped coupling units 112 and 114, which are dimensioned to engage coupling units of outer components 104 and 106, respectively.

The outer component 104 has an L-shaped cross section provided with a base side 121 that, as disclosed in previous embodiments, is formed with a free U-shaped end 122, which is spaced from the exterior surface of wall 101 so as to hold siding pieces in place. Extending from the opposite end of base side 121 is a sidewall 124 and an engaging element 138 that is provided with a coupling unit 126. The coupling unit 126 engages coupling unit 112 of inner trim component 102 in a manner described above.

A further outer component 106 of trim unit 100 includes a base side 130 spaced from the exterior surface of wall 103 and extending beyond the outside corner. Each of the opposite ends of base side 130 has a respective U-shaped end 136 and 128 formed so that, while free end 136 is configured to hold siding pieces covering the exterior surface of wall 103, the other end 128 is dimensioned to extend next to sidewall 124 of outer component 104. A partition 132, which is located between opposite ends 128 and 136 of base side 130, extends inwardly and, upon installation, terminates next to sidewall 124 of outer component 104. The engaging element 134 of outer component 106 is spaced closely from partition 132 and couples to engaging element 110 of inner component 102 in a manner disclosed above in reference to the previous embodiments. Similarly to the previously described embodiments, trim unit 100 helps avoid siding misalignments from one wall to the next, which often may be observed when the craftsman installs the known prior art trim units. The craftsman has an easy visual reference occurring via that outer trim component which is installed last.

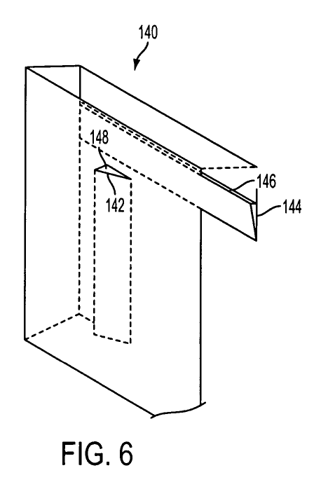

FIG. 6 illustrates a corner piece or block 140 used to cover the corners of the openings, such doors and windows. The inventive block 140 snaps over horizontal and vertical inner trim components, such as the one disclosed in reference to FIGS. 1-5 without being nailed thereto.

The corner block 140 is extruded with two perpendicularly extending outer coupling elements 142 and 144 extending in respective transversely extending planes. The coupling units have base surfaces 146 and 148, respectively, each of which engages a respective surface of the trim components of the inventive trim unit.

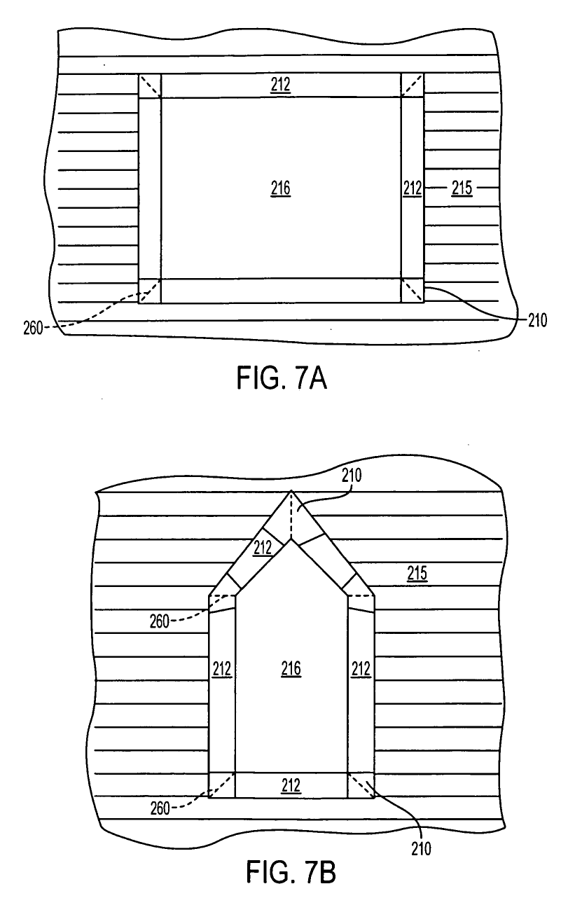

FIGS. 7A and 7B illustrate the exterior side of a housing wall provided with a plurality of siding panels 215 which are cut to define a window opening 216 provided with corner blocks or pieces 210 configured to cover adjacent trim components 212. As shown in FIG. 7A, window 216 may be rectangular and, thus, has its perimeter decorated by four trim units 212, each of which may be configured in accordance with the trim unit shown in FIGS. 1-5. Alternatively, window 216 may have a different configuration such as a cathedral window of FIG. 7B defining multiple corners wherein five trim components 212 are used. Therein, one trim component 212 meets at least another trim component 212 at a joint 260 in the form of a butt-joint, although joint 260 may also be a slip joint or any other kind of joint. To facilitate this operation, corner block 210 detachably engages a pair of converging trim components 212 defining a respective corner.

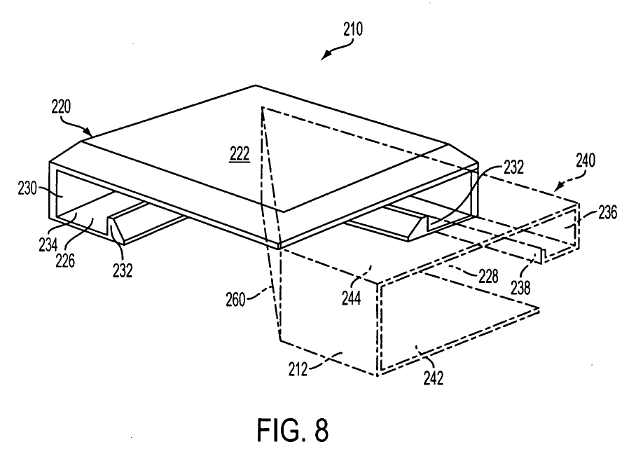

FIG. 8 illustrates corner block 210 and one of converging trims components 212 in an assembled state of corner block 210. A second trim component, which is not shown, is structurally identical to trim unit 212 and engages corner block 210 in the same manner as trim unit 212 as disclosed immediately below.

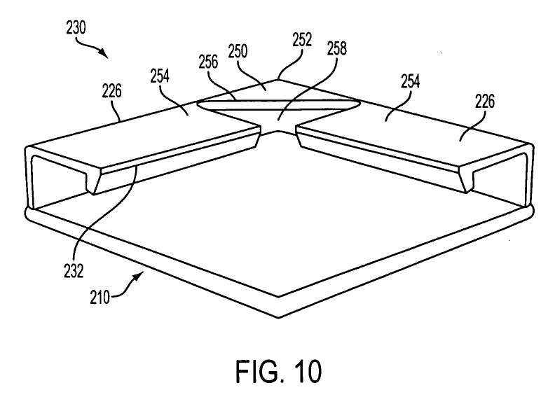

The corner block 210 has a body 220 that includes an outer face 222 and two flanges 226 that extend inwards from face 222 and are configured to engage respective trim units 212. Preferably, the face 222 is chamfered, as clearly seen in FIG. 10B, to provide a gradual interface between the longitudinal trim components and corner trim piece. Each of flanges 226 has a generally U-shaped channel defined between opposite flanks 230 and 232 and a bottom 234 that bridges flanks 230 and 232. The bottom 234 of flange 226 is substantially perpendicular to flanks 230 and 232; however, other polygonal or curved shapes of flange 226 may be successfully utilized within the scope of the invention as long as the flange has a generally U-shaped cross section. Having generally a U-shaped flange is advantageous because trim unit 212 has typically either a U-shaped collar 240 or J-shaped collar (not shown), which is surrounded by the inner surface of flange 226 of corner block 210.

Engagement between corner block 210 and trims 212 is realized by a snap-in operation during which corner block 210 is pushed onto and surrounds collar 240 of trim unit 212 so that one of opposite sides of collar 240, for example, a side 236, extends next to flank 230 of flange 226, whereas the other side 238 of color 240 abuts flank 232 of flange 226. Made from flexible material such as plastic or metal, trims 212 each yield to a force, generated by the craftsman who pushes corner block 210 onto trim units 212, and allow corner block 210 to snap in place. As a result, corner block 210 reliably engages converging trim units 212.

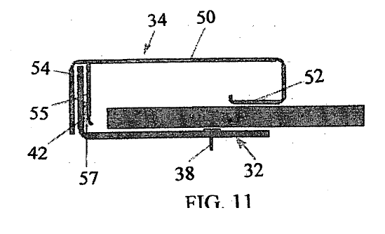

The trim units 212 each may be configured with two subcomponents 242 and 244. An inner component 242 is coupled to the surface to be covered by fasteners (not shown) and positioned to receive a plurality of crudely cut siding panels, which are, in turn, covered by an outer component 244 that engages inner component 242. For example, subcomponents 242 and 244 may have engaging elements (now shown) coupleable to one another in a manner disclosed in reference to FIGS. 1-5, or be caulked as explained in reference to FIG. 11. Of course, other configurations of trim units 212 can be used as well in conjunction with inventive corner block 210.

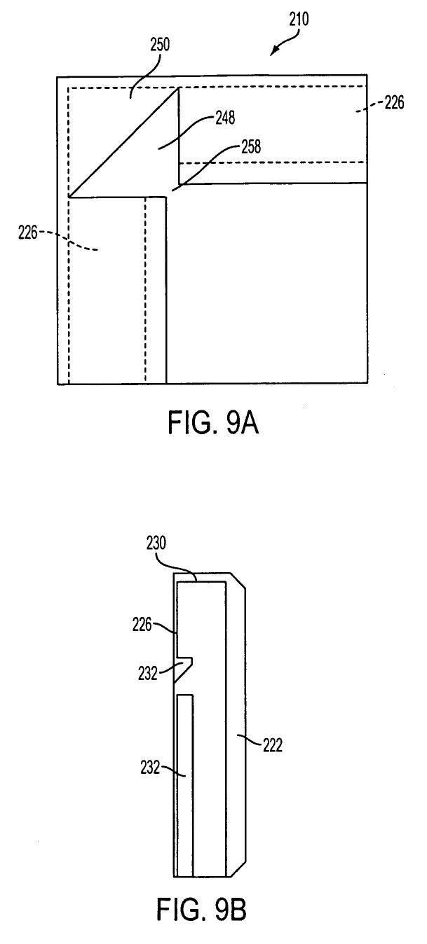

Referring to FIGS. 9A and 10 in addition to FIG. 8, the underside of corner block 210 has a cut-off region 258 of flanges 226. As a result, each flange 226 is relatively flexible which is particularly advantageous during engagement of corner peace 210 with trim components 212. A corner or tip panel 250 extends inwards from a corner 252 of trim piece 210 and covers the tips of converging trim units 212 in the assembled state of the inventive molding system. Inner edges 254 and 256 of flanges 226 and panel 250, respectively, thus, define triangularly shaped cut-off region 248 having a relatively narrow passage 258 (FIGS. 9A and 10). During installation, a corner region of each trim unit 212 (FIGS. 7A and 7B) is crudely cut approximately at a 45° angle and is substantially aligned with passage 258 of corner block 210. The corner block 210 is shown to be generally rectangular (FIG. 10), other shapes covering virtually any underlying trim configuration can be contoured to correspond to the trim configuration, provided that flange 226 of corner block 210 extends complementary to the collar of trim 212 in the assembled state of the inventive assembly. Consequently, the angle between the corner regions of the trim components may differ from a right angle. The corner block 210 effectively aligns converging trim components 212, reliably covering joint 260 (FIGS. 7A and 7B) between trim components 212 while keeping these pieces together.

Turning to FIG. 11, alternatively to or in addition to utilizing engaging elements 44 and 56, inner and outer trim components 32 and 34, respectively, can be secured against voluntary displacement relative to one another by caulking. In the context of the invention, the term “caulking” refers to the process of sealing a gap between two surfaces for the purpose of making it air or watertight. In accordance with this embodiment, outer trim component 34 has a partition 55 extending from base side 50 substantially parallel to side wall 54. The side wall 54 and partition 55 are spaced apart so as to define a gap therebetween which is dimensioned to receive side wall 42 of inner trim component 32. The juxtaposed surfaces of sidewall 42 and at least partition 55 are caulked, as shown by a reference numeral 57, for the purpose of making trim unit 30 air or watertight. There are hundreds of different types of caulk including, but not limited to, acrylic latex caulk, butyl rubber caulk, and silicon caulk. Preferably an acrylic/vinyl caulk is used as a sealant. Once the caulk has cured, the securement between the trim components is even stronger than the engagement between engaging elements 44 and 55 discussed in reference to FIGS. 1-3. The caulk 57 can also be used with each of the embodiments of the inventive trim unit shown in FIGS. 4-5. Also, the substantial viscosity of the vinyl caulk serves to hold trim components 32 and 34 in place even while the caulk is curing. While the coupling between inner and outer trim components 32 and 34, respectively, is strong, it is still possible to disengage them by applying an external force, if, of course, the need exists. Other kinds of caulk and sealants, including but not limited to butyl rubber caulk, silicon caulk, may be effectively used within the scope of the invention.

The specific features described herein may be used in some embodiments, but not in others, without departure from the spirit and scope of the invention as set forth. Many additional modifications are intended in the foregoing disclosure, and it will be appreciated by those of ordinary skill in the art that in some instances some features of the invention will be employed in the absence of a corresponding use of other features. The illustrative examples therefore do not define the metes and bounds of the invention.

What is claimed is:

1. A trim for covering a surface, the trim comprising a plurality of trim components configured to couple one another in an assembled state of the trim.

2. The trim of claim 1, wherein the trim components include an inner component coupleable to the surface and at least one outer component engaging the inner trim component in the assembled state of the trim.

3. The trim of claim 2, wherein the inner and outer components each have at least one base side and a side wall joined together.

4. The trim of claim 3, wherein the base side of the inner component is juxtaposed with and coupleable to the surface, the inner and outer components being engageable to one another so that the base sides of the inner and outer components, respectively, extend substantially parallel to one another and are spaced apart in the assembled state of the trim.

5. The trim of claim 4, wherein the base sides of the inner and outer components, respectively, each have a free end spaced from the side wall, the free ends defining an entrance into a space between the base sides of the inner and outer components in the assembled state of the trim, the space being configured to receive a crudely cut end of one or more siding secured against voluntary displacement and covered by the outer component in the assembled state of the trim.

6. The trim of claim 5, wherein the free end of the outer component has a generally U or J-shaped cross section configured to urge the crudely cut ends of the siding towards the surface to be covered in the assembled state of the trim.

7. The trim of claim 3, wherein the base sides of the inner and outer components each have at least one engaging element extending substantially parallel to and spaced from the side wall, the engaging elements detachably engaging one another to prevent voluntary displacement of the inner and outer components relative to one another in the assembled state of the trim covering the surface.

8. The trim of claim 7, wherein the engagement elements each have a substantially triangularly shaped free end, the engagement elements being made from flexible material and configured so that the free ends of the engaging elements of the inner and outer components, respectively, snap in place in the assemble state of the trim.

9. The trim of claim 3, wherein the base side of the inner component has one or more holes each configured to receive a trim nail for coupling the inner component to the surface.

10. The trim of claim 7, wherein the inner and outer components are configured to cover an inside corner of the surface, the outer component having two base sides diverging from one another and extending substantially parallel to and spaced from respective portions of the surface which form the inside corner, at least one of the base sides of the outer component having the engaging element coupleable with the engaging element of the inner component in the assembled state of the trim.

11. The trim of claim 7, wherein the inner and outer components are configured to cover an outside corner of the surface, the outer component having two subcomponents individually detachably engaging the inner component, each of the subcomponents having the engaging element coupleable to the engaging element of the inner component.

12. The trim of claim 3, wherein the outer component further comprises a partition extending from the base side and parallel to the side wall, the base side and partition forming a gap shaped and dimensioned to receive the sidewall of the inner component secured to at least the partition by caulking.

13. The trim of claim 1, wherein the plurality of components include
at least two inner components converging towards one another and configured to cover respective portions of the surface which define an opening in the surface, the inner components having respective end regions terminating next to one another, and
an outer corner block detachably coupleable to and covering the end regions of the inner components in the assembled state of the trim.

14. The trim of claim 13, wherein the corner block has a pair of flanges extending parallel to the respective end regions of the inner components in the assembled state of the trim, each of the flanges having a generally U-shaped or J-shaped cross-section operable to engage the end regions of the inner components in the assembled state of the trim.

15. The trim of claim 14, wherein the inner components each have a collar configured to detachably engage a respective one of the flanges of the corner block.

16. The trim of claim 15, wherein the collar of each of the inner components has an outer surface extending substantially complementary to an inner surface of the flange of the corner block and configured to prevent voluntary displacement between the inner components and the corner block in the assembled state of the trim.

17. The trim of claim 16, wherein the inner components each have an upper side opposing an inner surface of the corner block in the assembled state of the trim, a bottom side extending generally parallel to and spaced from the upper side, an inner side bridging the upper and bottom sides and spaced from the collar across the upper side, the collar and the bottom side of each of the inner components being spaced apart to define an opening configured to receive the flange of the corner block.

18. The trim of claim 17, wherein the flanges of the corner block each have a bottom flanked by an outer side and an inner sides under the inner surface of the corner block, the inner side of each of the flanges of the corner block terminating at a distance from the inner surface thereof so as to allow the upper side of the inner component to extend under and across the inner surface of the corner block in the assembled state of the trim.

19. The trim of claim 18, wherein the corner block has an outer surface extending substantially parallel to the inner surface and provided with a plurality of chamfered border regions.

20. The trim of claim 14, wherein the flanges of the corner block converge towards one another at an angle corresponding to an angle between the converging inner components, the flanges terminating at a distance from one another to define a passage therebetween configured to receive the end regions of the respective inner components in the assembled state of the trim.

21. The trim of claim 20, wherein the end regions of the respective inner components are slanted to form a joint fully covered by the corner block in the assembled state of the trim, the corner block further having a tip panel extending between the flanges into the passage and configured to prevent tips of the respective end regions of the inner components from voluntary displacement in the assembled state of the trim.

22. A trim configured to cover crudely cut ends of a plurality of siding covering an exterior surface comprising:
an inner component coupleable to the exterior surface; and
an outer component configured to detachably engage the inner component, the inner and outer components defining a space therebetween that is dimensioned to receive the crudely cut ends of the siding so as prevent voluntary displacement of the components relative to one another, keep the siding in place and prevent the crudely cut ends from being visible in an assembled state of the trim corresponding to engagement between the inner and outer components.

23. The trim of claim 22, wherein the inner and outer components each have:
a base side extending generally parallel to the exterior surface,
a side wall extending transversely to the base side, and
at least one engaging element extending from the base side parallel to the side wall, the engaging elements of the respective inner and outer components being configured to detachably engage one another.

24. The trim of claim 23, wherein the base side of the inner component has one or more holes provided closer to the side wall than to a free end of the base side and each configured to receive a trim nail for attaching the inner component to the exterior surface.

25. The trim of claim 23, wherein the engaging elements each have a coupling element spaced from the base side, the coupling elements of the respective inner and outer components being configured to frictionally slide against one another during displacement of the outer component towards the inner component and engage one another in the assembled state of the trim.

26. The trim of claim 25, wherein the coupling elements of the respective inner and outer engagement elements each have a triangularly shaped cross section defined by a slanted surface and an engaging surface, the engaging surfaces extending substantially parallel to the respective base sides and complementary to one another in the assembled state of the trim.

27. The trim of claim 25, wherein the coupling element of the engaging element of one of the inner and outer components has a projection and the coupling element of the other component has a formation configured to receive the projection.

28. The trim of claim 23, wherein the side wall of the outer component has a generally L-shaped end spaced from and opposing a free end of the base side of the inner component in the assembled state of the trim, the L-shaped end being configured to urge the crudely cut ends of the respective siding towards the exterior surface in the assembled state of the trim.

29. The trim of claim 23, wherein the inner and outer components are configured to engage one another so as to cover a flat region of the exterior surface.

30. The trim of claim 23, wherein the inner and outer components are configured to engage one another so as to cover a region of the exterior surface defining an inner corner.

31. The trim of claim 23, wherein the inner and outer components are configured to engage one another so as to cover a region of the exterior surface defining an outer corner of the exterior surface.

32. A trim for covering a corner region of a door or a window provided in an exterior surface, comprising a corner block having a body releasably engageable a pair of converging trim components which define the corner region.

33. The trim of claim 32, wherein the body has an outer side facing away from the exterior surface in an assembled state of the trim, and a plurality of flanges extending transversely to the outer side towards the exterior surface in the assembled state, the flanges each having one of a U-shaped and J-shaped cross-sections and configured to releasably engage the respective trim components.

34. The trim of claim 33, wherein the flanges of the corner block converge towards one another at an angle corresponding to an angle between the converging trim components, the flanges having respective end regions opposing to and spaced from one another so as to define a passage therebetween.

35. The trim of claim 34, wherein the body of the corner block further has a tip panel extending into the passage between the end regions of the respective flanges, the passage being configured to receive slanted end portions of the trim components terminating under the tip panel.

36. A method of installing a trim comprising the steps of:
coupling at least one inner trim component to a surface to be covered; and
positioning an outer component atop the at least one inner trim component; and
urging the outer component towards the at least one inner trim component, thereby coupling the components to one another so as to prevent the components from displacing relative to one another.

37. The method of claim 36, wherein the outer component is an outer trim component, the outer and inner trim components each having a base, a sidewall extending transversely to the base and joined thereto at a distance from a free end of the base, and at least one engagement element extending from the base side, the engagement element of the respective inner and outer trim components being configured to releasable engage one another.

38. The method of claim 37, further comprising
crudely cutting ends of a plurality of siding;
installing the plurality of siding so that the crudely cut ends of the respective siding lie atop or close to the free end of the base of the inner component before positioning the outer trim component; and
covering the crudely cut ends by the outer trim component, thereby keeping the crudely cut ends in place between the inner and outer trim components, whereas the crudely cut ends are prevented from voluntary displacement relative to the engaged inner and outer trim components and from being visible from outside.

39. The method of claim 38, wherein the engaged inner and outer trim components cover a flat region of the surface or an inner corner of the surface or an outer corner of the surface, the surface being an exterior surface.

40. The method of claim 36, further comprising:
coupling an additional inner component to the surface so that two inner trim components extend transversely to one another along surface regions defining a corner of a door or window in the surface, wherein end portions of the respective inner trim components oppose to one another and from a joint; and
releasably engaging the outer component to the end portions of the inner trim components so as to cover the joint and keep the inner components in place.

41. The method of claim 40, wherein the outer component comprises a corner block, the corner block being provided with an outer side extending substantially parallel to the surface and at least two flanges extending from the outer side towards the surface and configured to releasably engage the inner trim components.

42. The method of claim 36, wherein the outer component is an outer trim component having a base side, a side wall extending transversely to the base side and a partition extending from the base side parallel to the sidewall and defining a gap therebetween, the inner component having a base and a side wall extending transversely to the base and joined thereto.

43. The method of claim 42, further comprising:
driving the side wall of the inner component into the gap while urging the outer component towards the inner component; and
caulking the sidewall of the inner component with the partition of the outer component.
